(19) United States
(12) Patent Application Publication
(10) Pub. No.: US 2025/0217682 A1
(43) Pub. Date: Jul. 3, 2025

(54) STATISTICAL SAMPLING USING REJECTION-FREE PARALLEL TRIAL MARKOV CHAIN MONTE CARLO PROCESSES

(71) Applicant: Fujitsu Limited, Kawasaki-shi (JP)

(72) Inventors: Keivan DABIRI, Toronto (CA); Ali SHEIKHOLESLAMI, Toronto (CA); Hirotaka TAMURA, Yokohama (JP); Aki DOTE, Kawasaki (JP)

(73) Assignees: Fujitsu Limited, Kawasaki-shi (JP); THE GOVERNING COUNCIL OF THE UNIVERSITY OF TORONOTO, Toronto (CA)

(21) Appl. No.: 18/399,674

(22) Filed: Dec. 28, 2023

(51) Int. Cl. G06N 7/01

(52) U.S. Cl. CPC G06N 7/01

(57) ABSTRACT

A method may include obtaining replicas that represent estimated states of a system. A first replica having the lowest temperature in a first set of temperatures may be identified and written to a first state of a memory. The method may include performing a first Markov Chain Monte Carlo (MCMC) trial on each replica to simulate the effects of a change in the temperature of the respective replica. A second replica having the lowest temperature in a second set of temperatures may be identified and written to a second state of the memory. A first and second multiplicity of the first and second replicas may be calculated, the multiplicities representing estimations of the quantities of MCMC trials which would result in rejection. A representation of an end state of the system may be generated based on the first replica, the second replica, the first multiplicity, and the second multiplicity.

The embodiments discussed herein are related to statistical sampling using rejection-free parallel trial Markov Chain Monte Carlo processes.

### BACKGROUND

Sampling techniques may be used to obtain representations of state spaces. In some instances, Digital Annealers have been used as samplers, but require relatively significant computing resources. Further, Digital Annealers may distort the distribution of the state space such that the resulting representation may be incorrect. Additionally or alternatively, traditional Digital Annealer operations may perform operations in a manner that results in an invalid Markov Chain Monte Carlo (MCMC) process that may be used to sample the state spaces.

The subject matter claimed herein is not limited to embodiments that solve any disadvantages or that operate only in environments such as those described above. Rather, this background is only provided to illustrate one example technology area where some embodiments described herein may be practiced.

### SUMMARY

According to an aspect of an embodiment, a method may include obtaining replicas in which each replica includes multiple bits that represent a respective estimated state of a system. The method may include assigning each respective replica to a different corresponding temperature of a first set of temperatures and identifying a first replica having a first temperature lower than any other temperature in the first set of temperatures. The first replica may be written to a first state of a memory. The method may also include performing a first Markov Chain Monte Carlo (MCMC) trial on each respective replica in which a random respective bit that represents a change in the state of the system is flipped in each respective replica. Flipping the random bit may affect a change in the corresponding temperature of the respective replica. A second replica having a second temperature lower than any other temperature in a second set of temperatures may be identified in which the second set of temperatures includes the temperatures corresponding to each of the respective replicas after performing the first MCMC trial. The second replica may be written to a second state of the memory. The method may include generating a representation of the system based on the first state of the memory including the first replica and the second state of the memory including the second replica. The method may also include calculating a first multiplicity of the first replica representing an estimation of a first quantity of MCMC trials which would result in rejection if performed on the first replica at the first temperature. The method may additionally include calculating a second multiplicity of the second replica representing an estimation of a second quantity of MCMC trials which would result in rejection if performed on the second replica at the second temperature. The first multiplicity and the second multiplicity may be applied to the representation of the system, and parallel swapping may be performed with respect to the replicas by swapping adjacent temperatures of the first set of temperatures and the second set of temperatures. A second MCMC trial may be performed on each respective replica based on the second set of temperatures, and a representation of an end state of the system may be generated based on the first replica, the second replica, the first multiplicity, and the second multiplicity.

The object and advantages of the embodiments will be realized and achieved at least by the elements, features, and combinations particularly pointed out in the claims. It is to be understood that both the foregoing general description and the following detailed description are explanatory and are not restrictive of the invention, as claimed.

### BRIEF DESCRIPTION OF THE DRAWINGS

Example embodiments will be described and explained with additional specificity and detail through the use of the accompanying drawings in which:

FIG. 1 illustrates an example embodiment wherein information is written to DRAM according to at least one embodiment of the present disclosure;

FIG. 2 illustrates an example hardware architecture according to at least one embodiment of the present disclosure;

FIG. 3 illustrates an example noise generator according to at least one embodiment of the present disclosure;

FIG. 4 illustrates an example of a rejection-free Markov Chain Monte Carlo chain and a multiplicity corresponding to the rejection-free Markov Chain Monte Carlo chain according to at least one embodiment of the present disclosure;

FIGS. 5A and 5B illustrate a flowchart of an example method of statistical sampling according to at least one embodiment of the present disclosure; and

FIG. 6 is an example computing system.

### DESCRIPTION OF EMBODIMENTS

Large state spaces may be too large to exhaustively sample for obtaining representations of such state spaces. Stochastic sampling methods allow for approximations of systems that are too large to sample. Such processes involve sampling a random state of the system and then randomly changing a parameter of the state of the system to obtain another sample. By combining several samples, a probability distribution which gives an estimate of the overall system may be constructed. These stochastic processes may involve different algorithms for determining how the random next step is determined and how points of interest are to be treated.

For example, a Markov Chain Monte Carlo (MCMC) process may be used. MCMC processes involve generating a representation of a system with neurons representing parameters of the system. During MCMC trials, random changes to neurons are proposed. These changes are either accepted or rejected, depending on whether they move the representation closer to or farther away from a target outcome. The process is improved by running MCMC trials on many different replicas of the representation with each replica having its own weighting factor for whether a proposed change is accepted. This weighting factor is commonly referred to, and is referred to herein, as a “temperature” of a replica. As MCMC trials are performed on the multiple replicas, replicas having different temperatures may be swapped so that replicas may undergo MCMC trials at multiple different temperatures. Over time, the temperatures of the replicas may be slowly lowered, analogous to the way a metal is slowly cooled during annealing.

MCMC processes typically involve accepting or rejecting proposed moves that represent proposed changes to the state of the system. Each proposed move is compared against a known function proportional to a probability distribution. The proposed move is accepted or rejected based on its similarity to the known function. As such, the MCMC process may tend to sample states that follow the known function, meaning that the MCMC process may sample more states of higher probability density. Some MCMC processes are rejection-free, which can speed up the sampling process by reducing repetition of samples. MCMC processes can also be sped up by running several parallel trials on the same state space.

According to one or more embodiments of the present disclosure, a “Digital Sampler,” may be configured to sample state spaces. The Digital Sampler may utilize a rejection-free MCMC process and calculate a multiplicity for each trial. The multiplicity may represent an estimation of how many MCMC trials would result in rejection. This may be an estimation as to how many repetitions of a state space would occur in a rejection MCMC process even though a rejection-free MCMC process may be employed.

For example, if a replica, representing a state of a system, reaches a local minimum in a minimization problem, proposed changes in MCMC trials have a high probability of being rejected because any move away from the local minimum would appear to move away from the target solution. Therefore, a larger number of MCMC trials may result in rejections when at a local minimum. Accordingly, the calculated multiplicity may indicate whether a particular encountered state may correspond to a local minimum during a rejection free MCMC process. By contrast, if a rejection MCMC process were to be used, a greater number of iterations may be performed in the recognizing and moving out of the local extrema.

An advantage of calculating the multiplicity may accordingly be that a rejection-free MCMC process may be used instead of a rejection-based MCMC process, thus cutting down on repetition of samples and processing time while preserving the information related to local extrema. The multiplicity allows for detection of local minima or maxima by determining where the multiplicity is high. This allows a computing system to more efficiently form an accurate estimate of the state space. This may thus improve the functioning of a computing device configured to perform MCMC processes.

For instance, the embodiments of the present disclosure may be used to implement a Digital Sampler that is computationally more efficient than both ordinary MCMC trials and a digital annealer functioning as a sampler. For example, the Digital Sampler of the present disclosure may have lower overhead than a Digital Annealer used as a sampler. For example, the Digital Sampler may not require the final output to be rerouted as input for a new run as does a Digital Annealer. For instance, the Digital Sampler may record intermediate steps, creating a map of states it has sampled unlike a Digital Annealer, which outputs only the final state. The Digital Sampler may utilize multiple replicas, each representing an estimate of the state of a system. The replicas may each undergo MCMC trials accompanied by parallel swapping. The Digital Sampler may record the energy and state of one or more replicas after each stochastic trial. Thus, one or more samples are recorded after each trial. The Digital Sampler builds a representation of the system as MCMC trials occur. This may consume less overhead computing resources than recording the final state of several trials and then rerouting that state as input for the next round of trials as is done by a Digital Annealer. This reduced overhead may accordingly improve the functioning of a computing system that is configured to implement the Digital Sampler as compared to others that may perform sampling using a Digital Annealer.

Embodiments of the present disclosure are explained with reference to the accompanying figures.

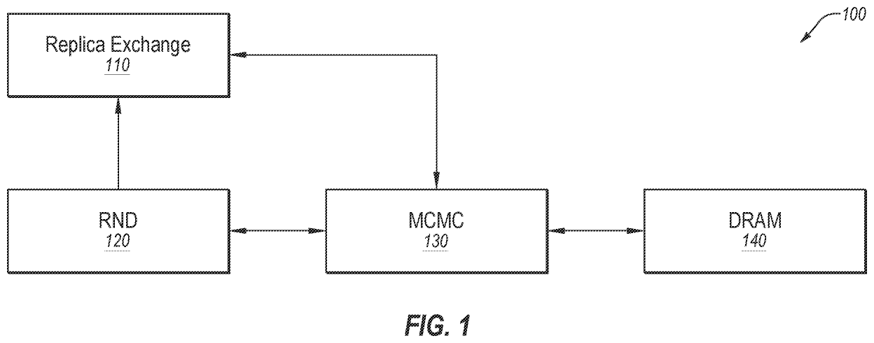

FIG. 1 illustrates an example Digital Sampler 100 configured to sample systems using a rejection-free MCMC process, according to at least one embodiment of the present disclosure. The Digital Sampler 100 includes a replica exchange block 110, a random number (RND) block 120, a MCMC block 130, and a DRAM block 140. In some embodiments, the replica exchange block 110 includes a parallel tempering (PT) kernel configured to perform replica swaps and temperature adjustments and removal. The PT kernel includes instructions for performing the steps of parallel tempering. Parallel tempering involves assigning a range of temperatures to many replicas representing a state or system. As stochastic trials are performed upon the replicas, the temperature assigned to each individual replica serves as a weighting factor to influence which moves the MCMC process will accept or reject. For example, a high temperature corresponds to a high probability of moving away from a local minimum in a minimization problem.

Parallel tempering involves changing the temperatures of the replicas while randomly swapping replicas between temperatures. Replicas may also be added or removed. This replica swapping allows states that exist in low temperatures to be exposed to high temperatures and states that exist in high temperatures to be exposed to low temperatures. This helps to cover a wider array of states of the system. For example, in a minimization problem, a replica that is trapped in a local minimum may escape the local minima by being exposed to a higher temperature. As another example, a replica with a high temperature may reach a state highly unlikely at low temperatures and then may remain there to move with greater accuracy by being exposed to a low temperature. In sampling, parallel tempering is beneficial because it causes the replicas to sample a wide array of the system at high temperatures and then focus on points of interest at low temperatures. The annealing and replica swaps increase the probability of sampling points of interest.

The replica exchange block 110 receives input from the RND block 120 and the MCMC block 130. The replica exchange block 110 receives the energy of all or some of the replicas from the MCMC block 130 and random numbers for each replica swap from the RND block 120. The energy of a replica may be used along with the temperature of the replica and one or more random numbers to determine whether or not a swap will take place. The replica exchange block 110 sends the determination of whether or not the swap will take place to the MCMC block 130. The replica exchange block 110 sends a PT replica index and a set of adjusted temperatures to the MCMC block 130. In some embodiments, the replica exchange block 110 may perform the replica exchange process such as described in U.S. Patent Application No. 17/142, filed Jan. 5, 2021 and incorporated by reference in the present disclosure in its entirety.

The MCMC block 130 may include a MCMC kernel configured to perform stochastic trials, perform parallel updates, find the sum of regular trials for multiplicity, calculate multiplicity, find a minimum Delta-energy at each iteration, and control the execution of one or more other kernels. Stochastic sampling is a method of determining a state change by way of random changes which in some instances may be accepted or rejected. By way of example, in some embodiments, the MCMC block 130 may perform stochastic trials for a certain number of replicas using a shift register that uses an output of a first bit flip (e.g., a first stochastic sample) as an input for a second bit flip (e.g., a second stochastic sample), which may facilitate conversion between serial and parallel sampling of the replicas. For instance in an example implementation, the MCMC block 130 may be configured to perform stochastic trials using the shift register for up to thirty-two replicas in which each replica includes up to 1,024 neurons in which the output of flipping a bit associated with a neuron for a first replica is used as the input for flipping a bit associated with a neuron for a second replica.

Each trial performed upon each replica may involve randomly proposing changes to the neurons of the replica that may or may not be enacted. For example, proposed changes to neurons may be accepted or rejected based on whether the proposed changes lower the energy of the replica or raise the energy of the replica, subject to weighting by the temperature of the replica. As outlined above, a high temperature tends to cause greater acceptance of changes and a lower temperature tends to cause lower acceptance of changes. As another example in a rejection-free stochastic trial (e.g., Digital Annealing), several proposed changes to neurons may be proposed and enacted.

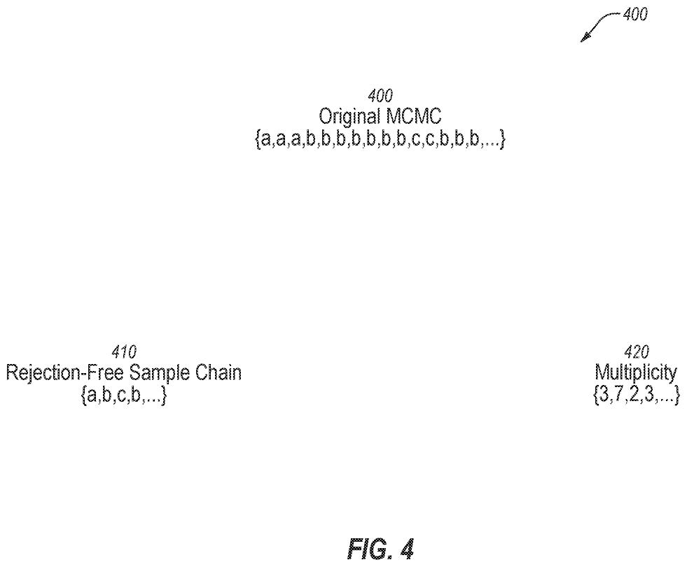

In some embodiments, determining and analyzing the multiplicity of the MCMC chain may reduce the number of samples that are analyzed to estimate the state of a particular system. Determining the multiplicity of the MCMC chain may facilitate generating a rejection-free MCMC chain as previously described such that the stochastic sampling of the MCMC chain may more readily escape from local extrema between samples. An example of the multiplicity of the rejection-free MCMC chain may be illustrated as shown in FIG. 4. FIG. 4 illustrates an example of an original MCMC chain 400 with a corresponding rejection-free MCMC chain 410 and a corresponding multiplicity 420 according to at least one embodiment of the present disclosure. The original MCMC chain 400 includes three replicas, a, b, and c, each representing a respective state. Repetition of any of the replicas indicates that a particular proposed move was rejected (e.g., because the particular proposed move does not move the state of the system towards some target solution).

In some embodiments, the multiplicity of a particular replica may be determined by performing a regular MCMC trial on each bit of the particular replica and finding the total number of proposed moves that are accepted. Each flipped bit that corresponds to an accepted move may be identified as a flag bit, in which a total energy of the particular replica, p, and the total number of flag bits are determined according to Equations (1) and (2), respectively:

$$p = \frac{1}{N} {\sum }_{i} {e}^{- \frac{Δ {E}_{i}}{T}} = \frac{1}{N} {e}^{- \frac{Δ {E}_{min}}{T}} {\sum }_{i} {e}^{\frac{( Δ {E}_{min} - Δ {E}_{i} )}{T}} \qquad ( 1 )$$

$${\sum }_{i} {flag}_{i} \approx {\sum }_{i} {e}^{\frac{Δ {E}_{i}}{T}} \qquad ( 2 )$$

In Equations (1) and (2), the sum of the flag bits, Σᵢ flagᵢ, may be approximately related to a difference in energy caused by the flipped bit, ΔEᵢ, and the temperature of the particular replica, T.

Based on the total number of flag bits, the multiplicity of the particular replica may be calculated according to Equation (3) based on the inverse of the sum of the flag bits:

$$M = \frac{N}{{\sum }_{i} {flag}_{i}} \qquad ( 3 )$$

The sum of the flag bits may be equal to zero in some instances (e.g., in situations where every proposed move is rejected). In these and other embodiments, the multiplicity may be computed according to Equation (4) in which ΔEₘᵢₙ represents a minimum energy change of the particular replica:

$$p = {e}^{\frac{- Δ {E}_{min}}{T}} \qquad ( 4 )$$

In some embodiments, the situation in which the sum of the flag bits equals zero may be avoided by adjusting Equation (2) relating to the sum of the flag bits using an offset value, which may be equal to the difference in energy caused by the flipped bit, as illustrated in Equation (5) below:

$${\sum }_{i} {flag}_{i} \approx {\sum }_{i} {e}^{\frac{( Δ {E}_{min} - Δ {E}_{i} )}{T}} \qquad ( 5 )$$

In these and other embodiments, the energy of the particular replica may be represented as shown in Equation (6):

$$p = \frac{1}{N} {e}^{- \frac{Δ {E}_{min}}{T}} {\sum }_{i} {flag}_{i} \qquad ( 6 )$$

In some embodiments, the multiplicity of the particular replica may be determined by calculating the minimum energy change and counting a number of coefficient terms associated with the minimum energy change in Equation (7) below:

$$p = {e}^{- Δ {E}_{min}} ( {a}_{0} {e}^{0} + {a}_{1} {e}^{- 1} + … {a}_{15} {e}^{- 11} + {a}_{16} {e}^{- 12} + … ) \qquad ( 7 )$$

In these and other embodiments, the energy of the particular replica may be estimated based on the energy coefficients, α₀ through α₁₆.

In some embodiments, the multiplicity 420 may be represented in terms of the probability of a proposed move being accepted or rejected, as shown in Equations (8) and (9) below:

$$Probability of Escape : α ( x ) = \frac{1}{N} {\sum }_{j = 1}^{N} {A}_{i} ( x ) \qquad ( 8 )$$

$$Probability of Rejection : 1 - α ( x ) \qquad ( 9 )$$

In Equation (8), the probability of escape, α(x), may be determined based a number of bits included in the particular replica, N, and individual probabilities determined for each bit according to a function Aᵢ(x).

The rejection-free MCMC chain 410 may include non-repeated instances of the replicas included in the original MCMC chain 400. As such, the rejection-free MCMC chain 410 includes four terms in the sequence: a, b, c, b. The multiplicity 420 may be computed based on the number of repetitions of a particular replica before a proposed move is accepted such that the multiplicity 420 corresponding to the original MCMC chain 400 includes the following sequence: {3, 7, 2, 3, . . . }. In some embodiments, the multiplicity 420 and a mean value of the multiplicity 420 may be estimated according to Equations (10) and (11) below, respectively:

$${M}_{S} = {t}_{S} ∼ {( 1 - α )}^{t - 1} α \qquad ( 10 )$$

$$〈 M ( x ) 〉 = \frac{1}{α ( x )} \qquad ( 11 )$$

In Equations (10) and (11), the multiplicity, Mₛ, may be estimated based on a stochastic value, tₛ, and the probability of escape as determined based on Equation (8). The mean value of the multiplicity, [symbol] M(x) [symbol] , may be determined based on the inverse of the probability of escape, a (x).

Based on the rejection-free MCMC chain 410 and the mean value of the multiplicity 420, an expected value of the system corresponding to the original MCMC chain 400, [symbol] f [symbol] , may be determined according to Equation (12) below:

$$〈 f 〉 = {lim}_{n \to ∞} \frac{{\sum }_{s = 1}^{n} {t}_{s} f ( {x}_{s} )}{{\sum }_{s = 1}^{n} {t}_{s}} = {lim}_{n \to ∞} \frac{{\sum }_{s = 1}^{n} f ( {x}_{s} ) / α ( {x}_{s} )}{{\sum }_{s = 1}^{n} 1 / α ( {x}_{s} )} \qquad ( 12 )$$

In Equation (12), the expected value of the system, [symbol] f [symbol] , may be determined stochastically based on the stochastic value, tₛ, and a state of the system, xₛ, or non-stochastically based the mean value of the multiplicity as determined in Equation (11).

Additionally or alternatively, the multiplicity 420 may be calculated by identifying and summing one or more flag bits that represent the bits of the replica that are flipped to induce an accepted move during a particular MCMC trial. In these and other embodiments, a minimum energy difference may be determined based on changes in energy corresponding to each of the replicas that may occur were the respective bits corresponding to the replicas to be flipped. In some embodiments, the changes in energy may be a determined minimum amount that the energy would change for a corresponding replica. An energy offset value may be subtracted from each of the minimum energy differences corresponding to each of the replicas. The multiplicity 420 may be calculated based on the summed flag bits and the energy offset value.

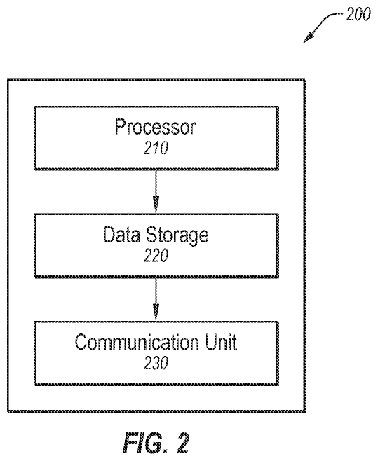

Returning to the description of FIG. 1, the MCMC block 130 may perform rejection-free stochastic trials in which one proposed change of many is enacted based on a change in energy, a temperature of a replica, and a random number, as explained in the description of FIG. 2.

The MCMC block 130 may perform updates with respect to the replicas. Updates to the replicas represent the accepted state changes of the replicas that are enacted upon the replicas. The updates may be performed in parallel, sequentially, or a combination thereof.

The MCMC block 130 may be configured to receive the PT replica index and the set of adjusted temperatures as input from the replica exchange block 110. The MCMC block 130 may also receive random numbers as input from the RND block 120 for calculating multiplicity and for the stochastic trials. The MCMC block 130 may send outputs relating to data for each replica at each iteration, including state data for each replica, a sum of flag bits, and a minimum energy difference, to the DRAM block 140. The MCMC block 130 may send data for each replica sequentially. Additionally or alternatively, the MCMC block 130 may send multiplicity data to the DRAM block 140.

The DRAM block 140 may receive data from the MCMC block 130 and transfer the data to DRAM. The DRAM block 140 may transfer data, such as the intermediate states of binary neurons for each replica, the sum of the flag bits, and the minimum energy difference, to DRAM for each iteration performed in the MCMC block 130. Additionally or alternatively, data may be transferred from the MCMC block 130 to the DRAM block 140 and subsequently to DRAM during the parallel swapping process such that some replicas are being sampled in the MCMC block 130 while other samples are simultaneously being transferred to DRAM. In some embodiments, the DRAM block 140 may transfer the multiplicity data from the MCMC block 130 to DRAM to preserve information about one or more intermediate states of the replicas, which may be less computationally expensive than determining the end states of the replicas via Digital Annealing. The intermediate samples of the system stored in DRAM may represent respective intermediate states of the system. By being stored in DRAM, the intermediate samples may be more quickly retrieved, and a particular end state of the system may be determined more quickly or with less computational resources expended.

Modifications, additions, or omissions may be made to the Digital Sampler 100 without departing from the scope of the present disclosure. For example, the designations of different elements in the manner described is meant to help explain concepts described herein and is not limiting. For instance, in some embodiments, the replica exchange block 110, the RND block 120, the MCMC block 130, and the DRAM block 140 are delineated in the specific manner described to help with explaining concepts described herein but such delineation is not meant to be limiting. Further, the Digital Sampler 100 may include any number of other elements or may be implemented within other systems or contexts than those described.

FIG. 2 illustrates an example hardware architecture according to at least one embodiment of the present disclosure. An arithmetic unit (AU) 200 may include a random number generator 210 and/or may receive random numbers from the RND block 120 of FIG. 1. The AU 200 may be a part of the MCMC block 130 of FIG. 1 and may perform the stochastic trials on the replicas. In some embodiments, the AU 200 may perform the stochastic trials in the following manner. The random number generator 210 may generate a random number for each neuron in a replica. In some embodiments, the random number generated for each neuron may be different from the random number generated for each other neuron. In these and other embodiments, the random number generator 210 may be part of the RND block 120 of FIG. 1.

The AU 200 may include a calculation block 220. The calculation block 220 may receive inputs including the temperature of the replica and the change in energy for each neuron. “Temperature” determines the relative probability of acceptance of a change in the state of a system. The temperature may be used as a scaling factor when performing a simulated or digital annealing process, such as parallel tempering of replicas. In some embodiments, the calculation block 220 may determine an index of minimum by calculating a vector, di, as shown in Equation (13):

$${d}_{i} = T log ( - log ( r ) ) + max ( 0 , Δ {E}_{i} ) \qquad ( 13 )$$

In Equation (13), T represents the temperature of the replica, r represents a random number from the random number generator 210, and ΔEᵢ represents the change in energy contemplated by the proposed bit-flip of neuron i. The index of minimum may represent an index corresponding to neuron i, which satisfies the condition of Equation (14) below, in which i represents the index of the neuron that includes the minimum of the vector di.

$$i = arg min ( {d}_{i} ) \qquad ( 14 )$$

In these and other embodiments, the AU 200 may perform parallel trials on two or more replicas simultaneously.

The AU 200 may include an update block 230 which updates the state of the neurons in the replica. The update block 230 may receive the index of the neuron i that satisfies Equation (14). In some embodiments, the update block 230 may update the replica to which the neuron i corresponds to include a bit-flip of the neuron i. In these and other embodiments, the update block 230 may update multiple different neurons corresponding to multiple different replicas in parallel.

Modifications, additions, or omissions may be made to the AU 200 without departing from the scope of the present disclosure. For example, the designations of different elements in the manner described is meant to help explain concepts described herein and is not limiting. For instance, in some embodiments, the random number generator 210, the calculation block 220, and the update block 230 are delineated in the specific manner described to help with explaining concepts described herein but such delineation is not meant to be limiting. Further, the AU 200 may include any number of other elements or may be implemented within other systems or contexts than those described.

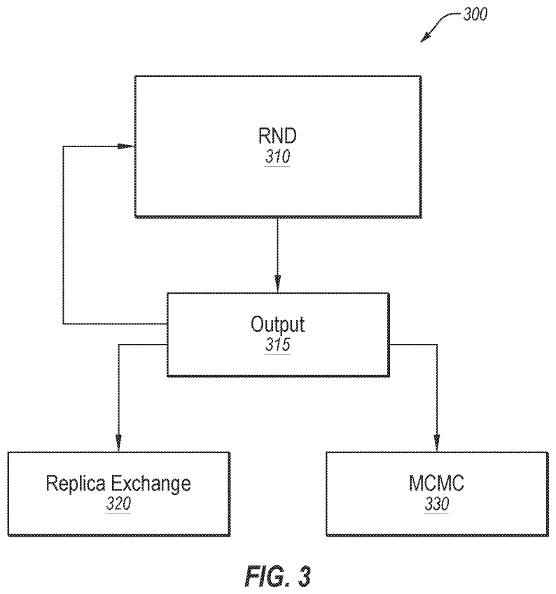

FIG. 3 illustrates an example noise generator 300 according to at least one embodiment of the present disclosure. The example noise generator 300 may include an RND block 310, an output 315, a replica exchange block 320, and a MCMC block 330. The RND block 310 may generate random numbers as the outputs 315, which may include independent and identically distributed random numbers such that each random number has the same probability distribution and selection of each of the random numbers is mutually independent relative to one another. In some embodiments, the outputs 315 be sent to the replica exchange block 320 and/or the MCMC block 330.

The outputs 315 may be sent to the replica exchange block 320 so that the random numbers may be included in the replica exchange process as described in relation to the Digital Sampler 100 and the AU 200 of FIGS. 1 and 2, respectively. Additionally or alternatively, the outputs 315 may be sent to the MCMC block 330 to facilitate generating one or more stochastic samples for a particular MCMC chain.

Modifications, additions, or omissions may be made to the noise generator 300 without departing from the scope of the present disclosure. For example, the designations of different elements in the manner described is meant to help explain concepts described herein and is not limiting. For instance, in some embodiments, the RND block 310, the output 315, the replica exchange 320, and the MCMC block 330 are delineated in the specific manner described to help with explaining concepts described herein but such delineation is not meant to be limiting. Further, the noise generator 300 may include any number of other elements or may be implemented within other systems or contexts than those described.

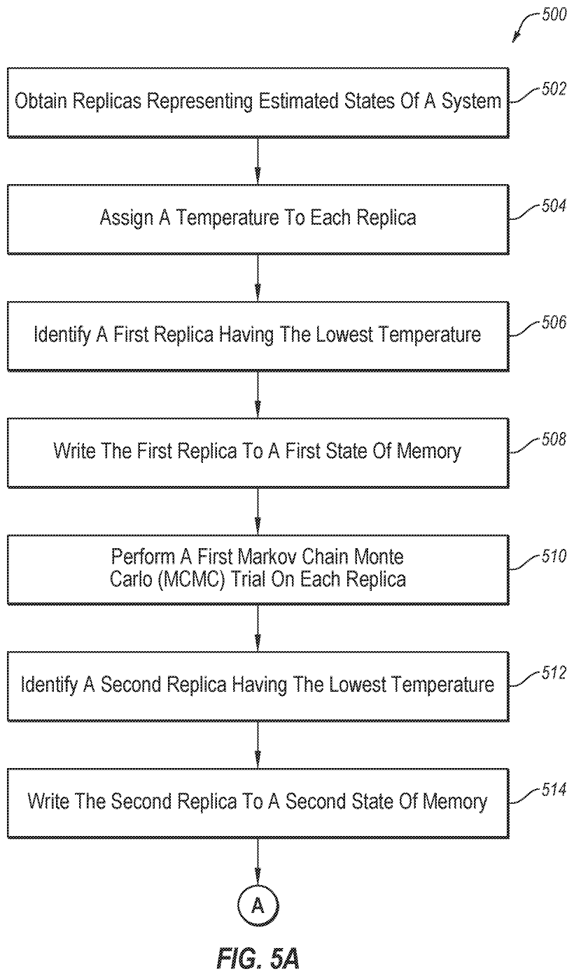

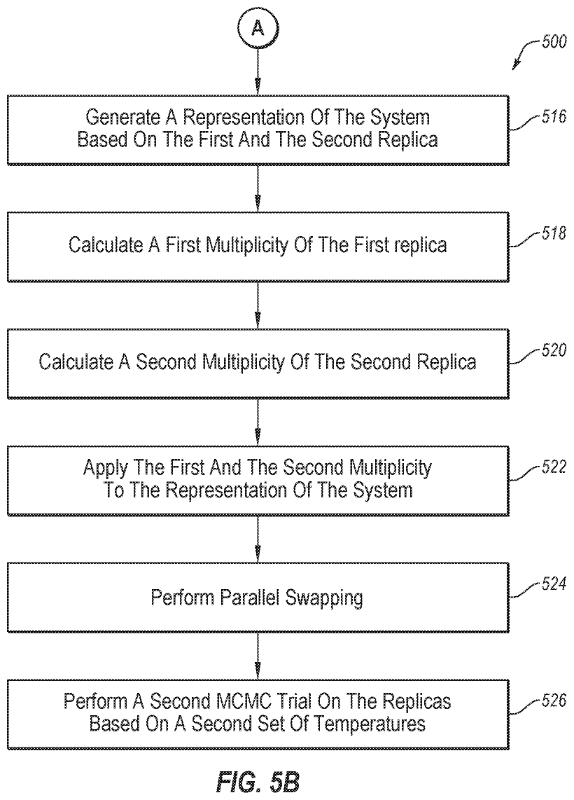

FIGS. 5A and 5B illustrate a flowchart of an example method 500 of statistical sampling according to at least one embodiment of the present disclosure. The method 500 may be performed by any suitable system, apparatus, or device. For example, a computing system consistent with and configured to perform one or more operations as described in relation to the replica exchange block 110 or the MCMC block 130 of FIG. 1 may be configured to perform one or more operations associated with the method 500. Although illustrated with discrete blocks, the steps and operations associated with one or more of the blocks of the method 500 may be divided into additional blocks, combined into fewer blocks, or eliminated, depending on the particular implementation.

The method 500 may begin at block 502, where replicas representing estimated states of a system are obtained. In some embodiments, each of the replicas may represent various estimated states of the system using multiple bits such that changes to one or more bits of the multiple bits correspond to changes in the estimated state of the system.

At block 504, each respective replica may be assigned a respective temperature of a first set of temperatures that represents a weighting factor of the respective replica. Replicas including relatively high temperatures may represent replicas that are more likely to include state changes (i.e., the replicas are more volatile, analogous to physical objects at high temperatures), which improves the ability of the replicas including high temperatures to escape from local extrema (e.g., a local minimum or a local maximum) during MCMC trials. Conversely, replicas including relatively low temperatures represent replicas that are more likely to reject proposed moves during MCMC trials. In other words, the low-temperature replicas include the replicas that are more resistant to changes during stochastic sampling. In some embodiments, the low-temperature replicas may include replicas that represent localized extrema of the system.

At block 506, a first replica having the lowest temperature of the first set of temperatures may be identified. In some embodiments, the first replica may represent a particular first intermediate state of a particular system that may be a localized or absolute extrema of the particular system.

At block 508, the first replica may be written to a first state of memory. In some embodiments, the first replica may be written to DRAM as described in relation to FIG. 1.

At block 510, a first MCMC trial may be performed on each of the replicas. In some embodiments, the first MCMC trial may involve flipping one or more random bits of the multiple bits corresponding to each of the replicas. Flipping the random bits associated with the replicas may simulate changes in the system that the replicas represent, which may also affect a change in the temperature of each of the replicas. After performing the first MCMC trial on each of the replicas, the temperatures of the replicas may be represented by a second set of temperatures because the flipped bits led to various temperature changes.

At block 512, a second replica having the lowest temperature of the second set of temperatures may be identified. In some embodiments, the second replica may represent a particular second intermediate state of the particular system that previously included the first replica.

At block 514, the second replica may be written to a second state of memory. In some embodiments, the second replica may be written to DRAM as described in relation to FIG. 1.

At block 516, a representation of the system may be generated based on the first replica and the second replica stored as the first state and the second state of memory, respectively, as described in relation to FIG. 1.

At block 518, a first multiplicity corresponding to the first replica may be calculated in which the first multiplicity represents an estimation of a first quantity of MCMC trials that may include some number of rejected moves if the MCMC trials were performed on the first replica at the first temperature. In some embodiments, the first multiplicity may be calculated using Equations (1)-(4) as described in relation to FIG. 4.

At block 520, a second multiplicity corresponding to the second replica may be calculated. The second multiplicity may represent an estimation of a second quantity of MCMC trials that may include some number of rejected moves if the MCMC trials were performed on the second replica at the second temperature. In some embodiments, the second multiplicity may be calculated using Equations (1)-(4) as described in relation to FIG. 4.

At block 522, the first multiplicity and the second multiplicity may be applied to the representation of the system generated at block 516. As described in relation to FIGS. 1 and 4, associating an original MCMC sample chain, such as any of the representations of the system described by the first replica, the second replica, or any other replicas, with a multiplicity may facilitate representing the system as a rejection-free sample chain, which may improve identification of local extrema included in the represented system or the accuracy of the estimated states associated with the represented system.

At block 524, parallel swapping may be performed with respect to the replicas based on the first set of temperatures and the second set of temperatures. In some embodiments, the parallel swapping may include randomly swapping the replicas between temperatures, such as the temperatures included in the first set of temperatures and the second set of temperatures, as described in relation to the PT kernel of FIG. 1.

At block 526, a second MCMC trial may be performed on the replicas based on the second set of temperatures. In some embodiments, the second MCMC trial may be performed using the parallel swapping process of block 524 such that the stochastic sampling of the second MCMC trial is more resistant to becoming stuck in a local extrema. Additionally or alternatively, a third MCMC trial, a fourth MCMC trial, or any other number of MCMC trials may be performed on the replicas, and a respective third replica, fourth replica, or any other number of replicas may be written to the memory to facilitate further sampling of intermediate states before determining a final state of the system.

Modifications, additions, or omissions may be made to the method 500 without departing from the scope of the disclosure. For example, the designations of different elements in the manner described is meant to help explain concepts described herein and is not limiting. Further, the method 500 may include any number of other elements or may be implemented within other systems or contexts than those described.

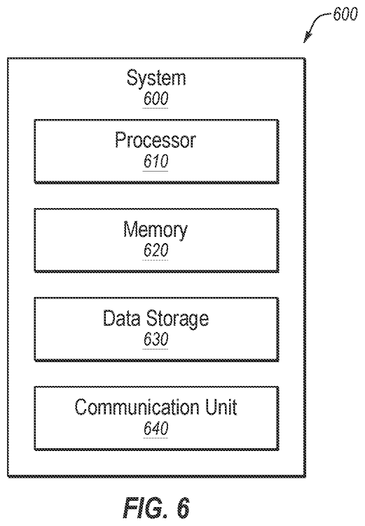

FIG. 6 illustrates an example computing system 600, according to at least one embodiment described in the present disclosure. The computing system 600 may include a processor 610, a memory 620, a data storage 630, and/or a communication unit 640, which all may be communicatively coupled. Any or all of the Digital Sampler 100 of FIG. 1, the AU 200 of FIG. 2, or the noise generator 300 of FIG. 3 may be implemented as a computing system consistent with the computing system 600.

Generally, the processor 610 may include any suitable special-purpose or general-purpose computer, computing entity, or processing device including various computer hardware or software modules and may be configured to execute instructions stored on any applicable computer-readable storage media. For example, the processor 610 may include a microprocessor, a microcontroller, a digital signal processor (DSP), an application-specific integrated circuit (ASIC), a Field-Programmable Gate Array (FPGA), or any other digital or analog circuitry configured to interpret and/or to execute program instructions and/or to process data.

Although illustrated as a single processor in FIG. 6, it is understood that the processor 610 may include any number of processors distributed across any number of network or physical locations that are configured to perform individually or collectively any number of operations described in the present disclosure. In some embodiments, the processor 610 may interpret and/or execute program instructions and/or process data stored in the memory 620, the data storage 630, or the memory 620 and the data storage 630. In some embodiments, the processor 610 may fetch program instructions from the data storage 630 and load the program instructions into the memory 620.

After the program instructions are loaded into the memory 620, the processor 610 may execute the program instructions, such as instructions to cause the computing system 600 to perform the operations of the method 500 of FIGS. 5A and 5B.

The memory 620 and the data storage 630 may include computer-readable storage media or one or more computer-readable storage mediums for having computer-executable instructions or data structures stored thereon. Such computer-readable storage media may be any available media that may be accessed by a general-purpose or special-purpose computer, such as the processor 610. For example, the memory 620 and/or the data storage 630 may include the DRAM of the DRAM block 140 of FIG. 1 such that the memory 620 and/or the data storage 630 may store one or more of the intermediate states of the system. In some embodiments, the computing system 600 may or may not include either of the memory 620 and the data storage 630.

By way of example, and not limitation, such computer-readable storage media may include non-transitory computer-readable storage media including Random Access Memory (RAM), Read-Only Memory (ROM), Electrically Erasable Programmable Read-Only Memory (EEPROM), Compact Disc Read-Only Memory (CD-ROM) or other optical disk storage, magnetic disk storage or other magnetic storage devices, flash memory devices (e.g., solid state memory devices), or any other storage medium which may be used to store desired program code in the form of computer-executable instructions or data structures and which may be accessed by a general-purpose or special-purpose computer. Combinations of the above may also be included within the scope of computer-readable storage media. Computer-executable instructions may include, for example, instructions and data configured to cause the processor 610 to perform a particular operation or group of operations.

The communication unit 640 may include any component, device, system, or combination thereof that is configured to transmit or receive information over a network. In some embodiments, the communication unit 640 may communicate with other devices at other locations, the same location, or even other components within the same system. For example, the communication unit 640 may include a modem, a network card (wireless or wired), an optical communication device, an infrared communication device, a wireless communication device (such as an antenna), and/or chipset (such as a Bluetooth device, an 802.6 device (e.g., Metropolitan Area Network (MAN)), a WiFi device, a WiMax device, cellular communication facilities, or others), and/or the like. The communication unit 640 may permit data to be exchanged with a network and/or any other devices or systems described in the present disclosure. For example, the communication unit 640 may allow the system 600 to communicate with other systems, such as computing devices and/or other networks.

One skilled in the art, after reviewing this disclosure, may recognize that modifications, additions, or omissions may be made to the system 600 without departing from the scope of the present disclosure. For example, the system 600 may include more or fewer components than those explicitly illustrated and described.

The foregoing disclosure is not intended to limit the present disclosure to the precise forms or particular fields of use disclosed. As such, it is contemplated that various alternate embodiments and/or modifications to the present disclosure, whether explicitly described or implied herein, are possible in light of the disclosure. Having thus described embodiments of the present disclosure, it may be recognized that changes may be made in form and detail without departing from the scope of the present disclosure. Thus, the present disclosure is limited only by the claims.

In some embodiments, the different components, modules, engines, and services described herein may be implemented as objects or processes that execute on a computing system (e.g., as separate threads). While some of the systems and processes described herein are generally described as being implemented in software (stored on and/or executed by general purpose hardware), specific hardware implementations or a combination of software and specific hardware implementations are also possible and contemplated.

Terms used in the present disclosure and especially in the appended claims (e.g., bodies of the appended claims) are generally intended as “open terms” (e.g., the term “including” should be interpreted as “including, but not limited to.”).

Additionally, if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations.

In addition, even if a specific number of an introduced claim recitation is expressly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” or “one or more of A, B, and C, etc.” is used, in general such a construction is intended to include A alone, B alone, C alone, A and B together, A and C together, B and C together, or A, B, and C together, etc.

Further, any disjunctive word or phrase preceding two or more alternative terms, whether in the description, claims, or drawings, should be understood to contemplate the possibilities of including one of the terms, either of the terms, or both of the terms. For example, the phrase “A or B” should be understood to include the possibilities of “A” or “B” or “A and B.”

All examples and conditional language recited in the present disclosure are intended for pedagogical objects to aid the reader in understanding the present disclosure and the concepts contributed by the inventor to furthering the art, and are to be construed as being without limitation to such specifically recited examples and conditions. Although embodiments of the present disclosure have been described in detail, various changes, substitutions, and alterations could be made hereto without departing from the spirit and scope of the present disclosure.

We claim:

1. A method comprising:
obtaining a plurality of replicas, wherein each replica of the plurality of replicas includes a plurality of bits that represent a respective estimated state of a system;
assigning each respective replica of the plurality of replicas to a different corresponding temperature of a first set of temperatures;
identifying a first replica having a first temperature lower than any other temperature in the first set of temperatures;
writing the first replica to a first state of a memory;
performing a first Markov Chain Monte Carlo (MCMC) trial on each respective replica of the plurality of replicas in which a random respective bit of the plurality of bits that represents a change in the state of the system is flipped in each respective replica of the plurality of replicas, wherein flipping the random bit affects a change in the corresponding temperature of the respective replica;
identifying a second replica having a second temperature lower than any other temperature in a second set of temperatures, the second set of temperatures including the temperatures corresponding to each of the respective replicas after performing the first MCMC trial;
writing the second replica to a second state of the memory;
generating a representation of the system based on the first state of the memory including the first replica and the second state of the memory including the second replica;
calculating a first multiplicity of the first replica representing an estimation of a first quantity of MCMC trials which would result in rejection if performed on the first replica at the first temperature;
calculating a second multiplicity of the second replica representing an estimation of a second quantity of MCMC trials which would result in rejection if performed on the second replica at the second temperature;
applying the first multiplicity and the second multiplicity to the representation of the system;
performing parallel swapping with respect to the plurality of replicas by swapping adjacent temperatures of the first set of temperatures and the second set of temperatures;
performing a second MCMC trial on each respective replica of the plurality of replicas based on the second set of temperatures; and
generating a representation of an end state of the system based on the first replica, the second replica, the first multiplicity, and the second multiplicity.

2. The method of claim 1, wherein the first MCMC trial and the second MCMC trial are each performed as rejection-free trials.

3. The method of claim 1, wherein writing the first replica to the first state of memory occurs concurrently with performing the first MCMC trial on each respective replica of the plurality of replicas.

4. The method of claim 1, wherein the first MCMC trial and the second MCMC trial each include generating a random number for use by a first neuron in a replica of the plurality of replicas in the first MCMC trial and providing the random number to a second neuron in the replica of the plurality of replicas for use in the second MCMC trial.

5. The method of claim 4, wherein calculating the first multiplicity and the second multiplicity is based on the random number used in the first MCMC trial and the second MCMC trial.

6. The method of claim 1, wherein calculating the first multiplicity comprises:
identifying one or more bits associated with a replica of the plurality of replicas as flag bits;
summing the flag bits;
calculating the first multiplicity using the sum of the flag bits.

7. The method of claim 1, wherein calculating the first multiplicity comprises:
determining a minimum energy difference based on potential changes in energy with respect to respective bit flips corresponding to each replica of the plurality of replicas;
identifying one or more bits associated with the replica corresponding to the minimum energy difference as flag bits;
summing the flag bits;
determining an offset value corresponding to the minimum energy difference; and
calculating the first multiplicity using the sum of the flag bits and the offset value.

8. One or more non-transitory computer-readable storage media configured to store instructions that, in response to being executed, cause a system to perform operations, the operations comprising:
obtaining a plurality of replicas, wherein each replica of the plurality of replicas includes a plurality of bits that represent a respective estimated state of a system;
assigning each respective replica of the plurality of replicas to a different corresponding temperature of a first set of temperatures;
identifying a first replica having a first temperature lower than any other temperature in the first set of temperatures;
writing the first replica to a first state of a memory;
performing a first Markov Chain Monte Carlo (MCMC) trial on each respective replica of the plurality of replicas in which a random respective bit of the plurality of bits that represents a change in the state of the system is flipped in each respective replica of the plurality of replicas, wherein flipping the random bit affects a change in the corresponding temperature of the respective replica;
identifying a second replica having a second temperature lower than any other temperature in a second set of temperatures, the second set of temperatures including the temperatures corresponding to each of the respective replicas after performing the first MCMC trial;
writing the second replica to a second state of the memory;
generating a representation of the system based on the first state of the memory including the first replica and the second state of the memory including the second replica;
calculating a first multiplicity of the first replica representing an estimation of a first quantity of MCMC trials which would result in rejection if performed on the first replica at the first temperature;
calculating a second multiplicity of the second replica representing an estimation of a second quantity of MCMC trials which would result in rejection if performed on the second replica at the second temperature;
applying the first multiplicity and the second multiplicity to the representation of the system;
performing parallel swapping with respect to the plurality of replicas by swapping adjacent temperatures of the first set of temperatures and the second set of temperatures;
performing a second MCMC trial on each respective replica of the plurality of replicas based on the second set of temperatures; and
generating a representation of an end state of the system based on the first replica, the second replica, the first multiplicity, and the second multiplicity.

9. The one or more non-transitory computer-readable storage media of claim 8, wherein the first MCMC trial and the second MCMC trial are each performed as rejection-free trials.

10. The one or more non-transitory computer-readable storage media of claim 8, wherein writing the first replica to the first state of memory occurs concurrently with performing the first MCMC trial on each respective replica of the plurality of replicas.

11. The one or more non-transitory computer-readable storage media of claim 8, wherein the first MCMC trial and the second MCMC trial each include generating a random number for use by a first neuron in a replica of the plurality of replicas in the first MCMC trial and providing the random number to a second neuron in the replica of the plurality of replicas for use in the second MCMC trial.

12. The one or more non-transitory computer-readable storage media of claim 11, wherein calculating the first multiplicity and the second multiplicity is based on the random number used in the first MCMC trial and the second MCMC trial.

13. The one or more non-transitory computer-readable storage media of claim 8, wherein calculating the first multiplicity comprises:
identifying one or more bits associated with a replica of the plurality of replicas as flag bits;
summing the flag bits;
calculating the first multiplicity using the sum of the flag bits.

14. The one or more non-transitory computer-readable storage media of claim 8, wherein calculating the first multiplicity comprises:
determining a minimum energy difference based on potential changes in energy with respect to respective bit flips corresponding to each replica of the plurality of replicas;
identifying one or more bits associated with the replica corresponding to the minimum energy difference as flag bits;
summing the flag bits;
determining an offset value corresponding to the minimum energy difference; and
calculating the first multiplicity using the sum of the flag bits and the offset value.

15. A system, comprising:
one or more processors;
one or more non-transitory computer-readable storage media configured to store instructions that, in response to being executed, cause the system to perform operations, the operations comprising:
obtaining a plurality of replicas, wherein each replica of the plurality of replicas includes a plurality of bits that represent a respective estimated state of a system;
assigning each respective replica of the plurality of replicas to a different corresponding temperature of a first set of temperatures;
identifying a first replica having a first temperature lower than any other temperature in the first set of temperatures;
writing the first replica to a first state of a memory;
performing a first Markov Chain Monte Carlo (MCMC) trial on each respective replica of the plurality of replicas in which a random respective bit of the plurality of bits that represents a change in the state of the system is flipped in each respective replica of the plurality of replicas, wherein flipping the random bit affects a change in the corresponding temperature of the respective replica;
identifying a second replica having a second temperature lower than any other temperature in a second set of temperatures, the second set of temperatures including the temperatures corresponding to each of the respective replicas after performing the first MCMC trial;
writing the second replica to a second state of the memory;
generating a representation of the system based on the first state of the memory including the first replica and the second state of the memory including the second replica;
calculating a first multiplicity of the first replica representing an estimation of a first quantity of MCMC trials which would result in rejection if performed on the first replica at the first temperature;
calculating a second multiplicity of the second replica representing an estimation of a second quantity of MCMC trials which would result in rejection if performed on the second replica at the second temperature;
applying the first multiplicity and the second multiplicity to the representation of the system;
performing parallel swapping with respect to the plurality of replicas by swapping adjacent temperatures of the first set of temperatures and the second set of temperatures;
performing a second MCMC trial on each respective replica of the plurality of replicas based on the second set of temperatures; and
generating a representation of an end state of the system based on the first replica, the second replica, the first multiplicity, and the second multiplicity.

16. The system of claim 15, wherein the first MCMC trial and the second MCMC trial are each performed as rejection-free trials.

17. The system of claim 15, wherein writing the first replica to the first state of memory occurs concurrently with performing the first MCMC trial on each respective replica of the plurality of replicas.

18. The system of claim 15, wherein the first MCMC trial and the second MCMC trial each include generating a random number for use by a first neuron in a replica of the plurality of replicas in the first MCMC trial and providing the random number to a second neuron in the replica of the plurality of replicas for use in the second MCMC trial.

19. The system of claim 15, wherein calculating the first multiplicity comprises:
identifying one or more bits associated with a replica of the plurality of replicas as flag bits;
summing the flag bits;
calculating the first multiplicity using the sum of the flag bits.

20. The system of claim 15, wherein calculating the first multiplicity comprises:
determining a minimum energy difference based on potential changes in energy with respect to respective bit flips corresponding to each replica of the plurality of replicas;
identifying one or more bits associated with the replica corresponding to the minimum energy difference as flag bits;
summing the flag bits;
determining an offset value corresponding to the minimum energy difference; and
calculating the first multiplicity using the sum of the flag bits and the offset value.
